(19) United States
(12) Patent Application Publication
(10) Pub. No.: US 2020/0400065 A1
(43) Pub. Date: Dec. 24, 2020

(54) INTERNAL COMBUSTION ENGINE

(71) Applicant: JOOST ENGINES LTD, Tonham, Surrey (GB)

(72) Inventor: Oliver Jukes, Tongham, Surrey (GB)

(21) Appl. No.: 16/764,663

(22) PCT Filed: Nov. 6, 2018
(86) PCT No.: PCT/GB2018/053213

§ 371 Date: May 15, 2020

(30) Foreign Application Priority Data
Nov. 17, 2017 (GB) 1719042.2

(51) Int. Cl. F02B 75/28; F02D 9/08; F02D 9/04; F01B 7/02

(52) U.S. Cl. CPC F02B 75/282; F02D 9/08; F02B 61/045; F01B 7/02; F02D 9/04

(57) ABSTRACT

An internal combustion engine has at least one piston configured to reciprocate within a combustion chamber. The engine has a transfer port, and exhaust port and a secondary port which may be adapted as either a secondary air transfer port, a secondary exhaust port, or as a two-way port acting selectively as i) an air transfer port and ii) an exhaust port. The engine may operate on a two stroke cycle. The engine may be for use submerged in a body of water, e.g. in an outboard motor, and with a cowling defining a volume near an outer wall of the combustion chamber. The volume can be selectively filled with water or exhaust gas for engine temperature optimisation.

### FIELD OF THE INVENTION

The present invention relates to an internal combustion engine, and in particular porting arrangements and cowling for an internal combustion engine.

### BACKGROUND OF THE INVENTION

Internal combustion engines and particularly two stroke engines are known to produce harmful exhaust emissions. The configuration and dimensions of ports within the engine are typically designed so as to optimise the efficiency of the combustion process for operation of the engine at power. In a conventional ported cylinder two stroke engine, post combustion exhaust gas exits the combustion chamber generally as the next charge of air-fuel mixture is drawn in to the combustion chamber. This process of clearing the combustion chamber is known as scavenging, and can result in unburnt fuel and air being drawn through the combustion chamber and out of the engine via the exhaust system, without combustion of the fuel taking place. There is a risk of loss of some portion of the fuel charge through the exhaust port, also known as short-circuiting, leading to higher unburnt hydrocarbon in the emissions and higher fuel consumption.

Two stroke engines benefit from mechanical simplicity and are light weight, and can generally be used in any orientation making them suitable for use in diverse applications from chainsaws, lawnmowers and other power tools to motorbikes, karts, lightweight planes and other vehicles.

Two stroke engines are also used in outboard motors for watercraft where their compact lightweight design is particularly advantageous, although stringent emissions regulations have made their use rare in many countries in recent years. The engine may be partially or totally submerged beneath the water. The temperature of the water affects the temperature in the combustion chamber, which can pose yet further challenges for the adoption of a submerged internal combustion engine for outboard applications.

A sub-optimal temperature in the combustion chamber leads to an inefficient combustion process and to the engine thereby producing a relatively high level of unburnt hydrocarbon emissions. For example, it was found that a drop in a cylinder head a temperature inside the combustion chamber from 110° C. to 80° C. results in a doubling in the level of unburnt hydrocarbons during combustion. Due to the cooling method of a submerged engine heat is constantly extracted regardless of the engine speed or load. Since the operating temperature of a submerged engine at idle can be below 30° C., unburnt hydrocarbon levels at idle can be a significant problem.

### SUMMARY OF THE INVENTION

A first aspect of the invention provides an internal combustion engine comprising: a pair of pistons in an opposed piston arrangement and a combustion chamber shared by the pair of opposed pistons, the pistons are configured to reciprocate within the combustion chamber, wherein the combustion chamber has a two-way port configured to selectively convey exhaust gas away from the combustion chamber, or to convey intake air into the combustion chamber.

Advantageously, the two-way or ‘hybrid’ port is selectively operated as an exhaust port to convey exhaust gas away from the combustion chamber and as an air transfer port to convey intake air into the combustion chamber. This dual functionality enables the two-way port to operate so as to improve the efficiency of the engine for different operating states of the engine, and the level of unburnt hydrocarbon emissions is thereby reduced.

An internal combustion engine has different operating states or settings. An engine “at idle”, “operating at idle”, “idling” or “at an idle setting” is not being used to produce a power output to drive an external load. At idle the engine is not operating under any loads external to the engine and its accessories. At idle, a throttle in the intake system is closed to reduce the volume of air and fuel entering the combustion chamber and minimise the fuel consumption of the engine. A reduced combustion of fuel may mean reduced exhaust emissions if the engine is operating efficiently and within a predefined optimum operating temperature range.

An engine “at power” or “operating at power” or “at a power setting” on the other hand, is operating under load and producing a rotation of the output shaft. At power, the throttle in the intake system is open to ensure the maximum volume of air and fuel is available to the combustion process.

A throttle is defined as an element, mechanism or system by which gas flow in a port or conduit is managed. The throttle is able to obstruct or check the flow of gas into the engine. The throttle is not necessarily in the form of a valve, even though the type of throttle most commonly used in engine design is a butterfly valve. A number of known designs of throttle are available to the skilled person. The terms throttle and throttle valve are used herein, without limitation as to the form of throttle being used.

The engine may further comprise an exhaust port in addition to the two-way port. The exhaust port may be configured to be selectively opened and closed such that when the exhaust port is closed, the two-way port is configured to convey exhaust gas away from the combustion chamber, and when the exhaust port is open the exhaust port may be configured to convey exhaust gas away from the combustion chamber and the two-way port is configured to convey intake air into the combustion chamber. The two-way port may be selectively operated as an exhaust port when the engine is operating at idle, and an air transfer port when the engine is operating at power.

The two-way port may have a smaller cross-sectional profile than a cross-sectional profile of the exhaust port. Directing exhaust gas through the two-way port with the engine in an idle state and through the exhaust port with the engine in a power state, enables pressure in the combustion chamber to be optimised when the engine is operating at idle and at power. Since the engine operates with a lower volume of air-fuel charge and hence exhaust gas at idle, directing exhaust gas through a port with a smaller cross-sectional profile enables pressure in the combustion chamber to be maintained.

During an engine cycle the two-way port may have a shorter open duration than the open duration of the exhaust port. When the engine is operating at idle, the two-way port can be configured to convey exhaust gas away from the combustion chamber where the exhaust port operation of the two-way port has a shorter open duration than the exhaust port to compensate for the excessive time available for incoming fuel to short circuit. With the engine operating at power, the exhaust port may have a larger open duration compared to the two-way port to enable efficient scavenging. When the engine is operating at power, the two-way port can operate as transfer port to provide a source of fresh air into the combustion chamber, where the two-way port shorter open duration can provide pressure drop in the combustion chamber to enable flow of fresh air into the combustion chamber as opposed to exhaust gases out of the combustion chamber.

During an engine cycle, the exhaust port may open prior to the two-way port. This enables pressure drop in the combustion chamber when the engine is operating at idle.

With the engine at power, the two way port may provide a source of fresh air into the combustion chamber at a location which blocks short circuiting of the new air-fuel charge entering the combustion chamber. Any additional gas leaving the combustion chamber once the exhaust gases have exited will be fresh air rather than the air-fuel mixture. This reduces or prevents short-circuiting of unburnt fuel in the exhaust gas.

The two-way port and the exhaust port may open into the combustion chamber generally at a first end of the combustion chamber. The engine may further comprise a transfer port configured to convey an air-fuel mixture to the combustion chamber. The transfer port may open into the combustion chamber generally at a second end of the combustion chamber opposite the first end. This ensures that the air-fuel charge is kept away from the exhaust port, and reduces or eliminates the risk of short circuiting of the air-fuel charge. The risk of part of the air-fuel charge escaping through the exhaust port prior to the combustion stage is reduced. This reduces the presence of unburnt fuel in the exhaust gas.

The two-way port may be selectively fluidly connected to an exhaust gas outlet or to an air inlet. A transfer valve may be located in a transfer conduit between the air inlet and the exhaust gas outlet. The transfer valve may be selectively movable between a closed position—in which the two-way port may be fluidly connected to the air inlet—and an open position—in which the two-way port may be fluidly connected to the exhaust gas outlet.

The exhaust port may have an exhaust valve selectively movable between a closed position in which the exhaust port may be closed and an open position in which the exhaust port may be open, and the exhaust valve and the transfer valve may be configured such that when the exhaust valve is open the transfer valve is closed, and vice versa.

The air inlet may have a one-way valve to permit air to flow from the air inlet to the two-way port.

The transfer port may be fluidly connected to an intake for admitting an air-fuel mixture. The engine may further comprise a throttle valve between the intake and the transfer port, the throttle valve movable between a closed position and an open position. The throttle valve and the exhaust valve may be configured such that when the throttle valve is open the exhaust valve is open, and vice versa. The engine may further comprise a one-way valve between the throttle valve and the intake port to permit the air-fuel mixture to flow from the intake to the transfer port.

A respective intake may be associated with each of the pair of pistons, one intake may be adapted to convey an air-fuel mixture to the combustion chamber, and the other intake may be adapted to convey air to the combustion chamber, each intake having a throttle valve.

The throttle valves may be configured to open and close simultaneously.

A second aspect of the invention provides an internal combustion engine comprising: at least one piston configured to reciprocate within a combustion chamber, wherein the combustion chamber has: a primary exhaust port having a substantially open configuration for carrying exhaust gas away from the chamber and a substantially closed configuration wherein exhaust gas substantially cannot pass through the primary exhaust port; and a secondary exhaust port configured to convey exhaust gas away from the combustion chamber when the primary exhaust port is substantially closed.

Advantageously, having two exhaust ports enabling the post combustion exhaust gases to exit the combustion chamber enables each exhaust port to be selectively used. The design and dimensions of each exhaust port can be configured so as to optimise the performance of the engine under different operating states. This enables the combustion process to be optimised so as to improve the efficiency of the engine for different operating states of the engine, and the level of unburnt hydrocarbon emissions is thereby reduced.

The secondary exhaust port may have a smaller cross-sectional profile than a cross-sectional profile of the primary exhaust port. Since the engine operates with a lower volume of air-fuel charge and hence exhaust gas at idle, directing exhaust gas through a port with a smaller cross-sectional profile enables pressure in the combustion chamber to be maintained.

During an engine cycle the secondary exhaust port may have a shorter open duration than the open duration of the primary exhaust port.

During an engine cycle the exhaust port opens prior to the secondary exhaust port.

The primary and secondary exhaust ports may open into the combustion chamber generally at a first end of the combustion chamber. The engine may further comprise an intake port configured to convey an air-fuel mixture to the combustion chamber. The intake port may open into the combustion chamber generally at a second end of the combustion chamber opposite the first end. This ensures that the air-fuel charge is generally kept away from the exhaust port, and reduces the risk of short circuiting of the air-fuel charge. The risk of part of the air-fuel charge escaping through the exhaust port prior to the combustion stage is reduced. This reduces the presence of unburnt fuel in the exhaust gas.

The primary exhaust port may have a primary exhaust valve selectively movable between a closed position in which the primary exhaust port is closed and an open position in which the primary exhaust port is open, and the secondary exhaust port may have a secondary exhaust valve selectively movable between a closed position in which the secondary exhaust port is closed and an open position in which the secondary exhaust port is open, the primary exhaust valve and the secondary exhaust valve may be configured such that when the primary exhaust valve is open the secondary exhaust valve is closed and vice versa. The port to be used as an exhaust port dependent on the engine operating state is thereby selected.

The transfer port may be fluidly connected to an intake for admitting an air-fuel mixture. The engine may further comprise a throttle valve between the intake and the transfer port, the throttle valve movable between a closed position and an open position.

The throttle valve and the primary exhaust valve may be configured such that when the throttle valve is open the exhaust valve is open, and vice versa. The engine may further comprise a one-way valve between the throttle valve and the transfer port to permit the air-fuel mixture to flow from the intake to the transfer port.

The at least one piston may include a pair of pistons in an opposed piston arrangement and the combustion chamber is shared by the pair of opposed pistons. A respective intake may be associated with each of the pair of pistons, one intake may be adapted to convey an air-fuel mixture to the combustion chamber, and the other intake may be adapted to convey air to the combustion chamber, each intake having a throttle valve.

The air intake throttle valve and the primary exhaust valve may be configured such that when the primary exhaust valve is closed the air intake throttle valve is closed. The air intake throttle valve is closed when the engine is operating at idle, and so the primary exhaust valve and the air intake throttle valves are thereby linked so that exhaust gas exits the combustion chamber through the secondary exhaust port when the engine is operating in an idle state.

An engine according to both the first aspect and the second aspect, wherein the secondary exhaust port of the second aspect is the two-way port of the first aspect.

A third aspect of the invention provides an internal combustion engine comprising: at least one piston configured to reciprocate within a combustion chamber, a transfer port generally adjacent a first end of the combustion chamber and configured to provide an air and fuel mixture to the chamber, an exhaust port generally adjacent a second end of the combustion chamber generally opposite the first end and configured to convey exhaust gas away from the chamber, and a secondary transfer port located generally adjacent the second end of the combustion chamber and generally opposing the exhaust port, wherein the secondary transfer port is configured to induct air into the combustion chamber.

The secondary exhaust port may have a smaller cross-sectional profile than a cross-sectional profile of the primary exhaust port. Since the engine operates with a lower volume of air-fuel charge and hence exhaust gas at idle, directing exhaust gas through a port with a smaller cross-sectional profile enables pressure in the combustion chamber to be maintained.

The secondary transfer port may be configured to induct air into the combustion chamber as the exhaust port conveys exhaust gas away from the chamber. The secondary transfer port may be selectively fluidly connected to an air inlet having a one-way valve to permit air to flow from the air inlet to the secondary transfer port.

During an engine cycle the secondary transfer port may have a shorter open duration than the open duration of the exhaust port.

During an engine cycle the exhaust port may open prior to the secondary transfer port.

In an engine according to both the first aspect and the third aspect, the secondary transfer port of the third aspect may be the two-way port of the first aspect.

In an internal combustion engine according to both the second aspect and the third aspect, the exhaust port of the third aspect may be the primary exhaust port of the second aspect.

A fourth aspect of the invention provides an internal combustion engine for use submerged in a body of water, comprising: at least one piston configured to reciprocate within a combustion chamber having a transfer port and an exhaust port, and a cowling defining a volume proximate an outer wall of the combustion chamber, wherein the volume is selectively fluidically connected to either the exhaust port or a body of water surrounding the engine.

Advantageously, directing exhaust gas to the cowling and so to the volume proximate the outer wall of the combustion chamber serves to displace excess cooling water in the cowling, maintain optimum combustion chamber temperature, and thus maintain the efficiency of combustion of the engine. At idle the engine is therefore able to run more efficiently than a conventional submerged engine, and so regulates the emissions of unburnt hydrocarbon exhaust gases. The engine at power operates at a higher temperature than when at idle, and potentially at a higher than optimal temperature range. Allowing water in to the cowling when the engine operates at power advantageously provides a source of cooling for the combustion chamber.

The cowling thereby contains a volume of either insulating exhaust gas with the engine operating at idle, or cooling water with the engine operating at power. By selectively directing either insulating exhaust gases or cooling water to the volume proximate the outer wall of the chamber, the engine can be maintained within (or at least closer to) its optimal operating temperature range. This controls the efficiency of the combustion process and hence regulates unburnt hydrocarbon emissions from the engine.

The cowling may have at least one opening arranged to correspond to the surrounding water height and fluidly connecting the volume to the surrounding body of water. The water may naturally enter the volume through the opening due to pressure head generated by being submerged, and the exhaust gas may exit the volume through the opening.

The engine may further comprise a transfer conduit selectively fluidly connecting the volume to the exhaust port, and a transfer valve in the transfer conduit selectively movable between an open position in which exhaust gas may be configured to flow from the exhaust port to the volume to insulate the engine from the relative cool body of water, and a closed position in which water may be configured to flow from the surrounding body of water to cool the engine.

The transfer conduit may have a pressure bleed open to the ambient atmosphere above the body of water. The volume may be configured to fill with exhaust gas when the engine is at an idle setting and to fill with water when the engine is at a power setting. When the engine is at idle setting, pressure bleed flow rate may be dwarfed by exhaust gas flow rate to enable a pressure difference to be conveyed to the cowling which exceeds water pressure head on the cowling and displaces the cooling water.

The engine may include a redundant scavenge pump that enables pumping fresh air into the cowling instead of using exhaust gases to displace cooling water from the cowling. When the engine is at power setting, the pressure bleed may eliminate the ability of the transfer port to convey pressure from the cowling to the scavenge pump.

The pressure bleed that is open to the ambient atmosphere above the body of water prevents water ingress into the scavenge pump. For example, in a circumstance where average pressure inside the scavenge pump in less than in the cowling, the pressure bleed may prevent a vacuum being conveyed between the scavenge pump and the cowling, thus preventing water ingress into the scavenge pump. The pressure bleed may be elevated above the body of water to prevent water from entering the transfer port.

The engine may further comprise a primary exhaust port in the combustion chamber, and the exhaust port may be a secondary exhaust port, the primary exhaust port having a substantially open configuration for carrying exhaust gas away from the chamber and a substantially closed configuration wherein exhaust gas substantially cannot pass through the primary exhaust port, and the secondary exhaust port may be configured to convey exhaust gas away from the combustion chamber when the primary exhaust port is substantially closed.

The engine may further comprise a primary exhaust port in the combustion chamber, and the exhaust port is a secondary exhaust port, the primary exhaust port having a substantially open configuration for carrying exhaust gas away from the chamber and a substantially closed configuration wherein exhaust gas substantially cannot pass through the primary exhaust port, and the secondary exhaust port is configured to convey exhaust gas away from the combustion chamber when the primary exhaust port is substantially closed.

The engine according to the fourth aspect may include the further features of the engine of the second aspect.

The engine according to the fourth aspect may include the further features of the engine of the first aspect, wherein the exhaust port of the fourth aspect may be the two-way port of the first aspect.

The engine according to the fourth aspect may include the further features of the engine of the third aspect, wherein the transfer port may be generally adjacent a first end of the combustion chamber, the exhaust port may be generally adjacent a second end of the combustion chamber generally opposite the first end and configured to convey exhaust gas away from the chamber, and may further comprise a secondary transfer port located generally adjacent the second end of the combustion chamber and generally arranged to minimise short circuiting into the exhaust port, wherein the secondary transfer port may be configured to transfer air into the combustion chamber.

The cowling defines a region or chamber adjacent the outer wall of the combustion chamber. The cowling may be of a separate jacket or sleeve construction specifically surrounding the chamber, or may form part of the overall engine construction and may therefore be used by the engine for other purposes in addition to ensuring insulating gas or cooling water reaches the volume proximate the chamber wall.

### BRIEF DESCRIPTION OF THE DRAWINGS

Embodiments of the invention will now be described with reference to the accompanying drawings, in which:

FIG. 1a is a partially disassembled view of an outboard motor having an opposed piston two stroke engine;

FIG. 1b is a part cross-sectional view of one example of a power transfer assembly for the engine of FIG. 1a;

FIG. 2 is a schematic view of the engine of FIG. 1a according to a first embodiment;

FIG. 3 is a schematic view of an internal combustion engine according to a first variant of the embodiment of FIG. 2 where the secondary port operates as a secondary exhaust port, showing gas flows in the combustion chamber when the engine is operating at idle;

FIG. 4 is a schematic view of an internal combustion engine according to a second variant of the embodiment of FIG. 2 where the secondary port operates as a secondary transfer port, showing gas flows in the combustion chamber when the engine is operating at power;

FIGS. 5a and 5b are schematic views of an internal combustion engine according to a third variant of the embodiment of FIG. 2 where the secondary port operates as a two way port, showing gas flows in the combustion chamber when the engine is operating at idle, and at power;

FIG. 6a is a schematic view of an internal combustion engine according to a fourth variant of the embodiment of FIG. 2, showing exhaust gas flowing to a cowling when the engine is operating at idle to warm the combustion chamber, and with exhaust gas supply to the cowling shut off and water from the surrounding body of water allowed to ingress into the cowling to cool the combustion chamber;

FIGS. 7a and 7b are schematic views of an internal combustion engine according to a second embodiment of the invention at idle, and at power;

FIGS. 8a and 8b are schematic views of an internal combustion engine according to a variant of the second embodiment of FIGS. 7a and 7b, showing the operation at idle, and at power;

FIG. 9 illustrates a variant of the embodiment in FIGS. 8a and 8b;

FIGS. 10a and 10b illustrate a single piston variant with a secondary port operating as a dedicated secondary exhaust port, showing the operation at idle, and at power; and

FIGS. 11a and 11b illustrate a simplified view of an internal combustion engine, showing the operation at idle, and at power.

### DETAILED DESCRIPTION OF EMBODIMENT(S)

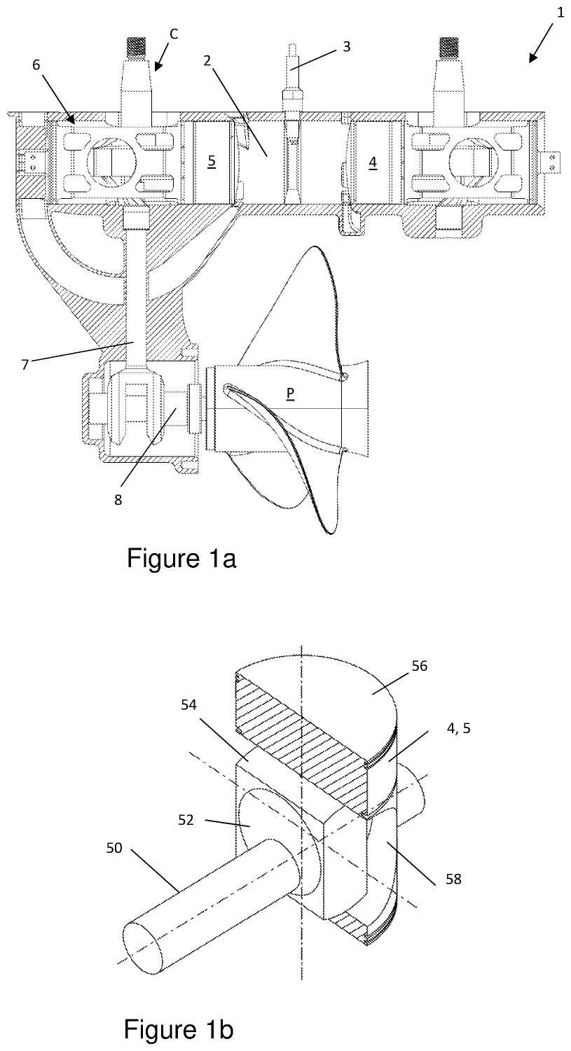

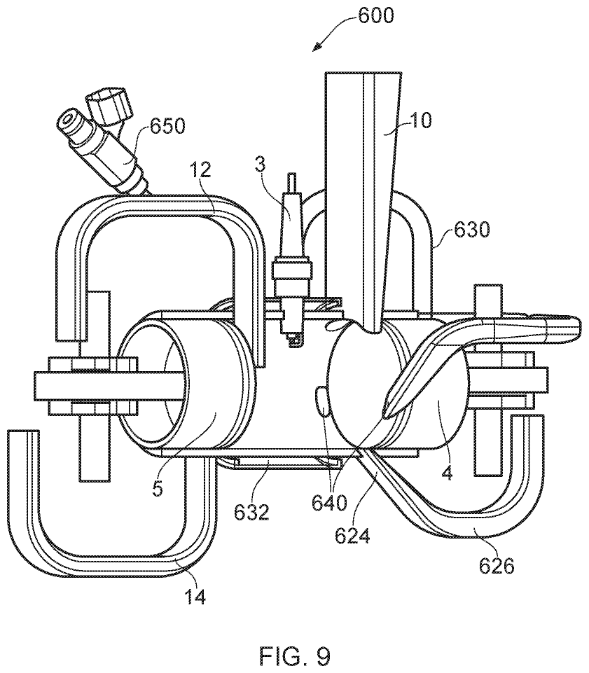

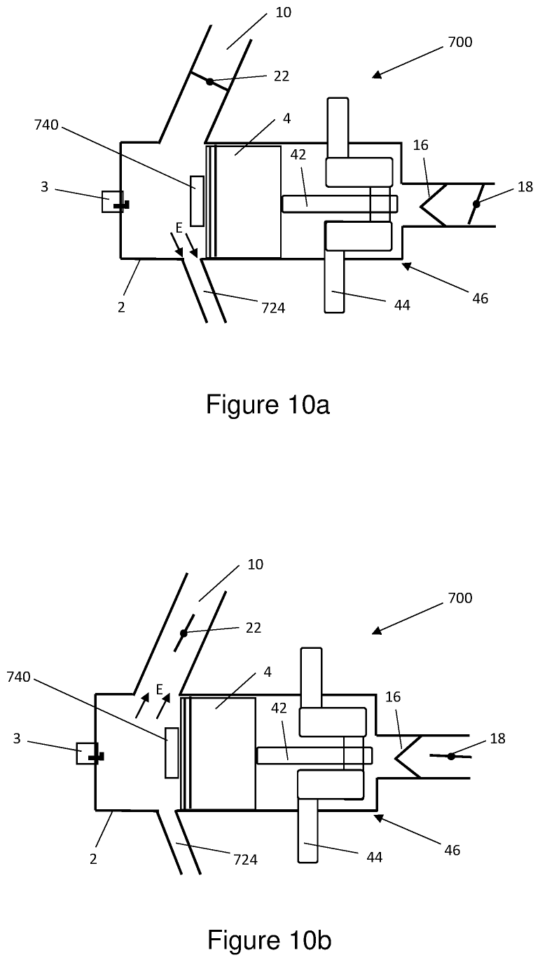

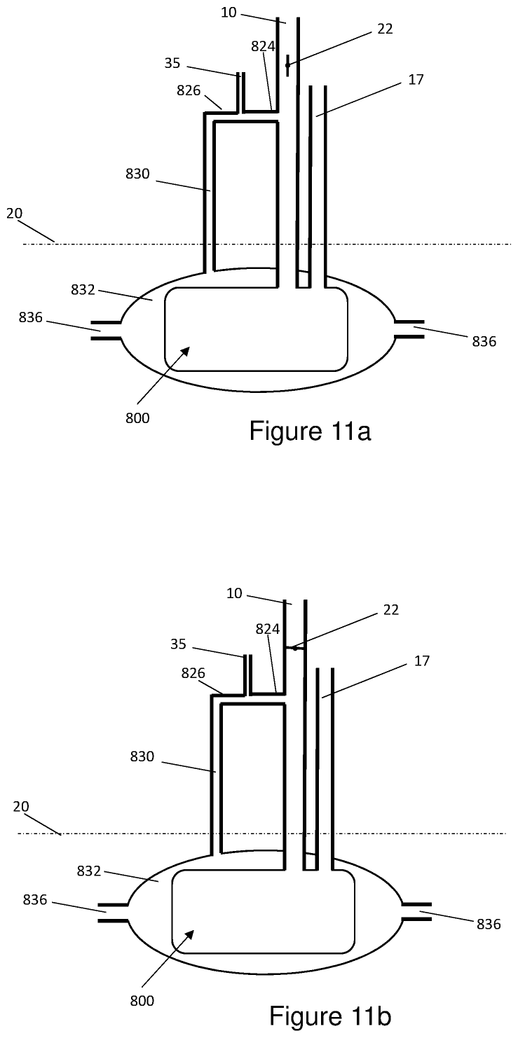

FIG. 1 provides a partially disassembled view of an outboard motor having an internal combustion engine 1. In the following FIGS. 1-10b, the internal combustion engine is a two stroke engine, however various aspects of the invention may equally be used with a four stroke internal combustion engine, and with other engine designs as shown in FIGS. 11a, 11b. In the following FIGS. 1-9, the engine is shown as having an opposed piston arrangement, however various aspects of the invention also apply to a single ended piston engine, as shown in FIGS. 10a, 10b, or to an engine configuration having multiple pistons operating in a single combustion chamber.

In FIG. 1, the engine is shown in an outboard motor for a watercraft engine with a propeller P. The engine is at least partially submerged in water. For example the engine may be used on a boat or other watercraft. In alternative embodiments the engine may be used to provide power to other equipment or machinery.

In a two stroke internal combustion cycle, an air-fuel mixture or charge is compressed in the combustion chamber during the compression stroke. Ignition of the charge in the combustion chamber forces the piston to reciprocate away from top dead centre on its return or power stroke. Toward the end of the power stroke, the piston exposes the intake and exhaust ports. A fresh air-fuel charge enters the chamber and the combustion exhaust gases are expelled via the exhaust port. The piston then begins another compression stroke.

The engine 1 has a combustion chamber 2, with a source of ignition, such as a spark plug 3, located within the combustion chamber 2. The engine 1 has two pistons 4 and 5 located opposing each other within the cylinder 6. The combustion chamber 2 is shared by the two opposed pistons 4, 5. The pistons 4, 5 reciprocate within the cylinder 6, and are situated generally opposing each other. In the illustrated embodiments, the opposed pistons reciprocate linearly along axis X. In the outboard motor the axis X is beneficially generally horizontal to provide a small frontal area for the engine but the axis X may be in any orientation. Both pistons 4, 5 reciprocate so as to be at top dead centre at the end of the compression stroke. Top dead centre refers to the position of the piston within the chamber during an operating cycle, irrespective of the orientation of the engine. In alternative embodiments, the engine may have more than two pistons arranged so as to generally oppose each other. The pistons may reciprocate within the chamber and have differing positions relative to each other at different stages of the operating cycle. The engine is shown described in one possible orientation, however the engine may be located and operate at any angle.

Each piston 4, 5 is connected to a power transfer mechanism C used to convert the reciprocating motion of the pistons 4, 5 into a rotational motion of the respective output shafts 7 (coupled via a timing belt—not shown) which drive a common drive shaft 8, which in turn drives the propeller P of the boat or other craft. In the illustrated embodiments of FIGS. 1 to 9, the power transfer mechanism C operates within an intermediate chamber in the body of the piston.

The power transfer mechanism is best shown in FIG. 1b. The output shaft 7 has a main shaft portion 50 and an eccentric portion 52. The main shaft portion 50 is rotatably mounted on bearings in the engine casing (see FIG. 1a) and passes through a slot in the piston. The eccentric portion 52 appears circular when viewed in the direction of the output shaft rotational axis. The eccentric portion 52 is rotatably mounted in a bore of a sliding bearing 54.

The piston 4 or 5 is movable relative to the casing in reciprocating motion between a top dead centre position (TDC), and a bottom dead centre position (BDC). TDC and BDC refer to specific positions of the piston during an operating cycle and apply irrespective of the orientation of the engine. When the piston 4, 5 is at TDC a working face of the combustion head is at its closest position to a working face of the piston 4, 5 so that the volume of the combustion chamber is at its minimum and the volume of the secondary or supercharging chamber is at its maximum. When the piston 4, 5 is at BDC the working face of the combustion head is at its furthest position from the piston 4, 5 so that the volume of the combustion chamber 2 is at its maximum and the volume of the secondary or scavenge chamber is at its minimum.

As the piston 4, 5 moves along its axis in reciprocating motion between TDC and BDC, curved bearing surfaces of the sliding bearing 54 remain in sliding contact with a bore 58 of the piston 4, 5, and the sliding bearing 54 moves with the piston in the direction of the piston axis X. The eccentric portion 52 additionally causes the sliding bearing 54 to move relative to the piston along a movement path substantially transverse to the cylinder axis in reciprocating motion. The sliding bearing 54 generally follows a circular path about the centre-line of the output shaft 50, and moves with the centre point of the rotating eccentric portion 52. The sliding bearing 54 and the piston 4, 5 follow simple harmonic motion in the direction of the piston axis with respect to the angle of rotation of the output shaft 50. The curved bearing surfaces of the sliding bearing 54 may be curved in one or more directions and may be part-cylindrical, cylindrical, part-spherical, spherical, barrelled, etc.

The linear to rotary power transfer mechanism (including the bore 58 of the piston 4, 5, the sliding bearing 54 and the output shaft 50) is substantially sealed from the intake system for the engine 1 and is substantially sealed from the combustion chamber 2 and the supercharging chambers by gas seal rings and oil seal rings such that the power transfer mechanism is self-contained within a power transfer assembly chamber of the piston.

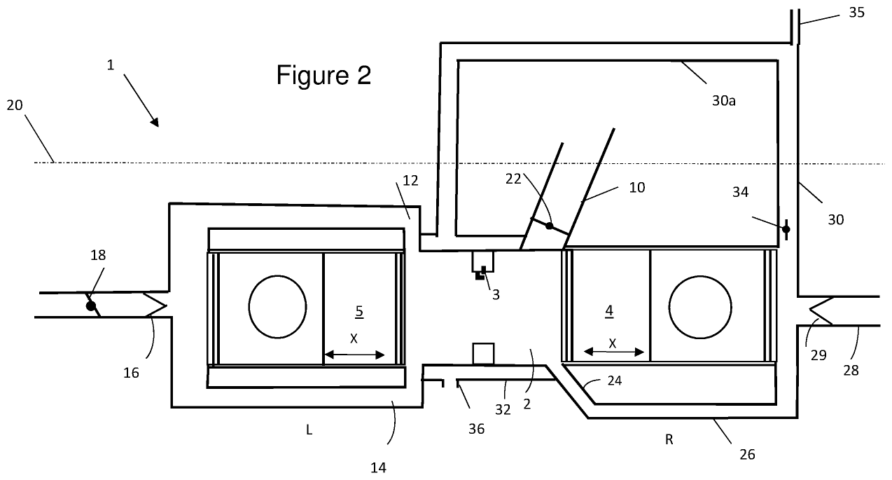

FIG. 2 provides a schematic view of a first embodiment of the engine 1. Details of the power transfer mechanism are omitted for clarity. The opposing pistons 4 and 5 are located within the cylinder. The cylinder walls and an end or working surface 4a and 5a of each piston 4, 5 together form the boundary of the combustion chamber 2.

In FIG. 2, each piston 4, 5 is a double ended piston, so that as the piston 4, 5 carries out a compression stroke in the combustion chamber 2, low pressure in a secondary or supercharging chamber at the opposing end of the piston 4, 5 acts to draw in a new air-fuel charge to the intake system. The intake system comprises transfer conduits leading to transfer ports 12, 14. The transfer ports 12, 14 open into the combustion chamber 2 via apertures in the wall of the combustion chamber 2.

The intake system and the transfer ports 12, 14 are located generally on one side of the engine, at one end of the combustion chamber 2. FIG. 2, this is the left hand side L of the engine 1. For ease of reference, the pistons will be referred to as the right hand piston 4 and the left hand piston 5, reflecting the exemplary illustrated configuration of the engine. The transfer ports 12, 14 are opened and closed by the reciprocating action of the left hand piston 5. Towards the end of the power stroke, the movement of the pistons 4 and 5 reveals the apertures of transfer ports 12 and 14 in the combustion chamber 2. The transfer ports 12, 14 are thereby opened and the next air-fuel mixture or charge is drawn into the combustion chamber 2 due to the pressure differential between the combustion chamber and the secondary chamber. The transfer ports 12, 14 in FIG. 2 are shown opening into the combustion chamber 2 at locations generally opposing each other. One transfer port 12 opens in an upper region of the combustion chamber 2 nearest a surface 20 of the surrounding water. The second transfer port 14 opens into the lower region of the combustion chamber 2, generally opposite the first intake port 12. The skilled person will be aware of various designs and location possibilities of the air intake system and ports. For example, in alternative embodiments there may be only a single transfer port.

A one way valve 16 located in the air intake system ensures that the air-fuel charge only travels towards the combustion chamber 2. In the illustrated embodiment of FIG. 2, the one way valve 16 is a reed valve, however alternative forms of one way valve suitable for use in an engine will be known to the skilled person.

The volume of air-fuel charge reaching the combustion chamber 2 is controlled by a throttle 18 located in the air intake system. The throttle 18 serves to control the flow of the air-fuel charge into the chamber 2. The throttle 18 moves between a closed position and an open position. In FIG. 2 the throttle 18 is shown as a butterfly valve, however alternative forms of throttle are well known to the skilled person. At idle, the throttle 18 is closed and the volume of air-fuel flow to the combustion chamber 2 is at a minimum. At power, the throttle 18 is open and the volume of air-fuel flow into the combustion chamber 2 increases to support the power output of the engine 1.

An exhaust port 10 allows post combustion exhaust gases to leave the combustion chamber 2 and exit to atmosphere, as shown above the water line 20 but optionally could be below the water line. The exhaust port 10 opens into the combustion chamber 2 at a location at an opposite end of the combustion chamber 2 to the transfer ports 12, 14. In the illustrated embodiment of FIG. 2, the exhaust port 10 is located on the right hand side R of the engine 1. The aperture of the exhaust port 10 in the combustion chamber 2 is opened and closed by the reciprocating action of the piston 4 on the right hand side R of the engine 1.

Such a porting arrangement results in ‘uniflow’ scavenging as the fresh air-fuel charge entering the combustion chamber 2 pushes out the exhaust gas through the exhaust port 10, both gas flows moving in the same direction. The dimensions of the exhaust port 10 are such as to support the volume of exhaust gas exiting the combustion chamber 2 when the engine is operating at power.

FIGS. 2 to 8 show the opposing pistons 4 and 5 in a position corresponding to approximately the end of the power stroke, i.e. generally around bottom dead centre. The openings of the transfer ports 12, 14 and exhaust port 10 are exposed within the combustion chamber 2. The air-fuel mixture is therefore able to pass into the chamber via the transfer ports 12, 14. If the exhaust valve 22 is open, exhaust gas is able to exit the chamber 2 through the exhaust port 10.

The exhaust port 10 has an exhaust valve 22. The exhaust valve 22 is selectively movable between a closed position and an open position. When the exhaust valve 22 is closed, the exhaust port 10 is closed. When the exhaust valve 22 is open, the exhaust port 10 is open. The exhaust valve 22 is shown as a butterfly valve 22 in FIGS. 2-8. In alternative embodiments various known valve designs may be used.

A secondary port 24 opens into the combustion chamber 2. The function and purpose of the secondary exhaust port 24 will be described in detail below. The opening of the secondary port 24 into the combustion chamber 2 is also located generally on the right hand side of the engine 1. The opening of the secondary port 24 is located generally opposite the opening of the exhaust port 10 within the combustion chamber 2. The exhaust port 10 aperture into the combustion chamber 2 is located generally in the upper region of the combustion chamber, nearest to the waterline 20, whilst the secondary port 24 opening is opposite the exhaust port and generally in the lower region of the combustion chamber 2. The secondary port 24 is opened and closed by the action of the right hand piston 4, similarly to the exhaust port 10.

The secondary port 24 extends into a secondary or transfer conduit 26. The transfer conduit 26 passes adjacent, and connects to, the secondary chamber of the right hand piston 4. The transfer conduit 26 divides at a location along its length. The transfer conduit 26 divides into an air inlet 28 and an exhaust outlet 30. The air inlet 28 opens to atmosphere. The one way valve 29 allows gas flow into the engine 1 only, in a direction towards the combustion chamber 2. FIG. 2 shows the one way valve 29 to be a reed valve. In alternative embodiments, use of various known designs of one way valve are possible.

The exhaust outlet 30 does not open directly to the atmosphere but instead extends into a further transfer conduit 30a. The further transfer conduit 30a exits into a cowling 32 surrounding the outer wall of the cylinder in the region of the combustion chamber 2. The exhaust outlet 30 has a secondary or transfer valve 34 to enable the exhaust outlet 30 to be opened or closed to gases flowing from the combustion chamber 2 or into the engine 1 from the air inlet 28. In the illustrated embodiment of FIG. 2 the secondary valve 34 is a butterfly valve. In alternative embodiments, use of various known designs of valve are possible.

The cowling 32 provides a jacketed area surrounding the outer wall of the combustion chamber 2. The cowling 32 defines a volume. The further transfer conduit 30a provides an inlet to the cowling 32 from the secondary port 24 and the secondary conduit 26. The cowling 32 also has an opening 36 fluidically connecting the volume to the surrounding body of water.

A pressure bleed 35 is located in the further transfer conduit 30a. The pressure bleed 35 exits to ambient atmosphere above the waterline 20. The pressure bleed 35 prevents water ingestion during transient throttling, for example where the engine is switching from idle to power, as will be described below under combustion chamber temperature optimisation. The pressure bleed 35 may be designed to a specific diameter to control the pressure, it may also be interchangeable or it may be actively adjustable during operation in order to optimise performance.

The secondary port 24 may be used in a variety of ways, e.g. as a secondary exhaust port, a secondary transfer port, or as a two-way port, as will be explained below.

The first embodiment may also include a Schnuerle porting system (not shown). Schnuerle ports are well known in the art, particularly in two stroke engines, and are commonly used to improve the scavenging efficiency in a cylinder. Schnuerle ports are positioned within the cylinder to direct a gas flow in order for the exhaust gases to efficiently exit the cylinder and limit turbulent mixing with the air-fuel mixture AF. The Schnuerle ports are configured to convey exhaust gas from the combustion chamber at idle and power modes, so that at idle the Schnuerle ports convey the exhaust gases the secondary port 24 and at power the Schnuerle ports convey exhaust gases to the exhaust port 10.

### Secondary Exhaust Port

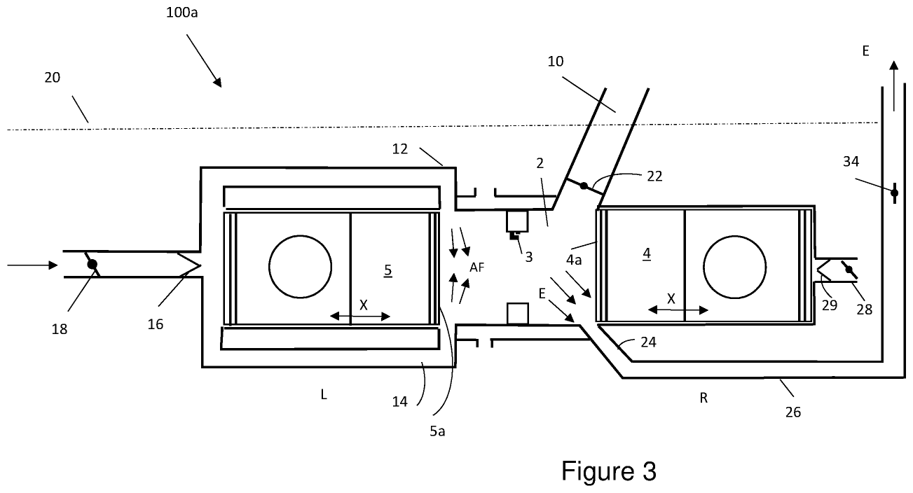

In a first variant, shown in FIG. 3, the secondary port operates as a dedicated secondary exhaust port when the engine is operating at idle. The engine 100a is simplified compared with the engine 1 of FIG. 2 such that the secondary port 24 extends into the transfer or secondary conduit 26 and exits to atmosphere.

When the engine 100a is operating at idle, the throttle 18 located in the intake system is closed. This reduces the volume of the air-fuel mixture AF flowing into the combustion chamber 2 to a minimum, and controls the air-fuel charge AF received by the combustion chamber 2 for each revolution of the engine 100a. The exhaust port 10 leading away from the combustion chamber 2 is sized for larger volumes of exhaust gas emitted when the throttle 18 is open. When the engine 100a is operating at idle, exhausting post combustion gas through the exhaust port 10 potentially leads to inefficient scavenging, as the dimensions of the exhaust port are such that part of the next air-fuel charge AF may be drawn through the exhaust port also. This leads to a reduced pressure in the combustion chamber 2. A lower than optimal pressure leads to inefficient combustion, and hence increased levels of unburnt hydrocarbon emissions.

The exhaust valve 22 is therefore shut when the engine 100 is at idle in order to close off the exhaust port 10 leading from the combustion chamber 2. Post combustion exhaust gases E instead exit the combustion chamber 2 during the power stroke via the secondary port 24 operating as a secondary exhaust port 24. The transfer or secondary exhaust valve 34 is open. The secondary exhaust port 24 has a cross-sectional profile that is smaller than the cross-sectional profile of the primary exhaust port 10. Dimensions of the secondary exhaust port 24 are optimised for the scavenging process when the engine is operating at idle. This maintains combustion chamber pressure at a higher level than if the primary exhaust port 10 were to be used, and hence assists in maintaining the efficiency of the engine 100a and regulating unburnt hydrocarbon emission levels and the presence of unburnt fuel in the exhaust gases.

When the engine is at power (not shown in FIG. 3), the throttle 18 is open, and exhaust gases E exit the combustion chamber through the primary exhaust port 10. The primary exhaust valve 22 is open, and the secondary exhaust or transfer valve 34 is closed so that the secondary exhaust port 24 is not used.

### Secondary Transfer Port

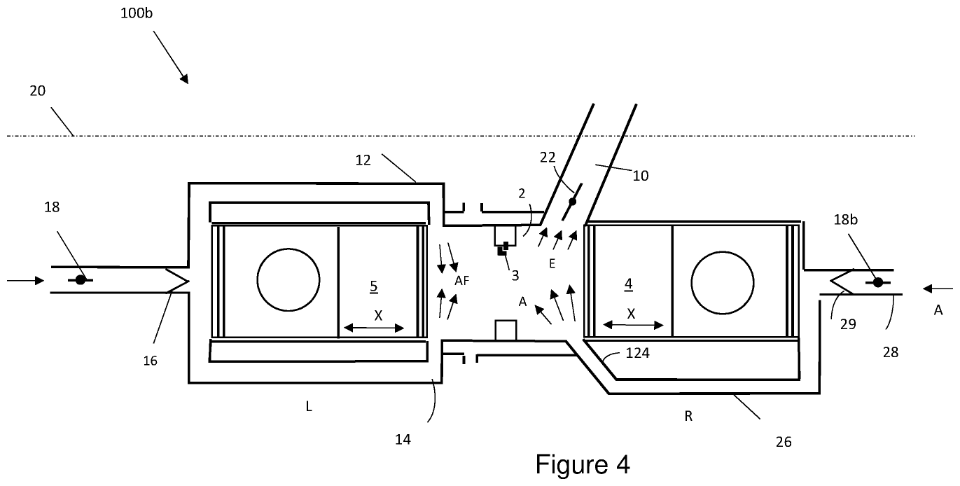

FIG. 4 is a schematic view through an engine 100b according to a second variant of the illustrated embodiment of FIG. 2. Many of the features of the engine 100b are common with FIG. 2, and so only those structural and functional features which differ or are significant to the operation of the second variant of FIG. 4 are described below. Numerals of features which differ in structure or operation from the previous embodiment are incremented by 100 for clarity.

The structure and location of the secondary port 124 is as described above for FIG. 3. In the variant of FIG. 4, the secondary port operates as a secondary, fresh air transfer port 124. The secondary transfer port 124 extends into the transfer conduit 26 and then to an air inlet 28, which leads to atmosphere.

The air-fuel mixture or charge AF reaches the combustion chamber 2 through the transfer ports 12, 14 located on the left hand side L of the engine 100. The exhaust valve 22 is open and exhaust gases E escape to atmosphere through the exhaust port 10.

The gas flow in the combustion chamber 2 is such that low pressure occurs on the power stroke. This pressure differential enables the next air-fuel charge AF to be drawn into the combustion chamber 2 and pushes exhaust gas E out through the exhaust port 10. On the right hand side R of the engine 100b, the secondary or supercharging chamber operated by the right hand piston 4 draws fresh air A into the secondary chamber on the compression stroke. The airflow is controlled by a throttle 18b located in the air inlet 28. The one way valve 29 ensures the fresh air A remains in the secondary chamber and is compressed on the return or power stroke. As the secondary transfer port 124 opens towards the end of the power stroke, fresh air A is therefore also drawn in to the combustion chamber 2 through the secondary transfer port 124. The secondary transfer port 124 may also include a control valve (not shown), such as a reed valve or timing valve, to prevent any exhaust gas from entering the secondary transfer port 124 during the power stroke.

Since the secondary transfer port 124 opens into the combustion chamber 2 at a location generally opposite the exhaust port 10, any excess gases drawn or inducted into the exhaust port 10 once the exhaust gases E are removed from the combustion chamber 2 will be fresh air A from the secondary port 24 and not the air-fuel mixture AF of the next charge. The location of the fresh air A entry into the combustion chamber 2 serves to block the air-fuel charge AF transferring from one side of the combustion chamber 2 (the left hand side L as shown in FIG. 3) to the area of the exhaust port 10. This port arrangement reduces the probability of the new air-fuel charge AF passing across the combustion chamber 2 and being drawn out through the exhaust port 10. Short circuiting is therefore reduced compared with conventional two stroke engines, and the presence of unburnt fuel in the exhaust gases is thereby reduced.

FIG. 4 shows the engine 100 operating at power with the throttle 18 in the intake system open, the exhaust port 10 aperture exposed within the combustion chamber 2 and the exhaust valve 22 open. At idle (not shown), the throttle 18 in the intake system is shut, and the engine 100 operates as at power with air A drawn in through the fresh air transfer port 124. The variants of FIGS. 3 and 4 can be additively combined, for example there may be two secondary ports, with one operating as a secondary exhaust port and another operating as a secondary air intake, thus combining variants one and two above. They may also include a Schnuerle porting arrangement (not shown) as described for the first embodiment.

### Two Way Secondary Port

Alternatively, the variants of FIGS. 3 and 4 can be combined so that the secondary port is then selectively operated as an exhaust port when the engine is operating at idle, and an air transfer port when the engine is operating at power.

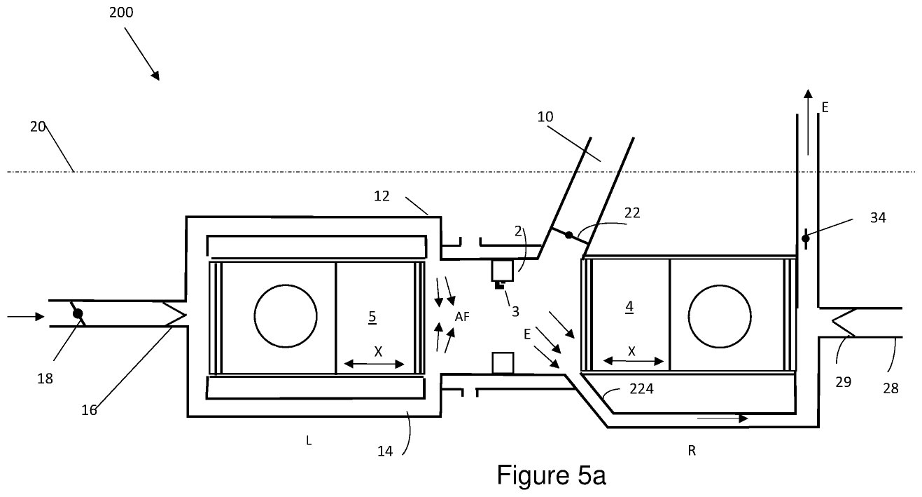

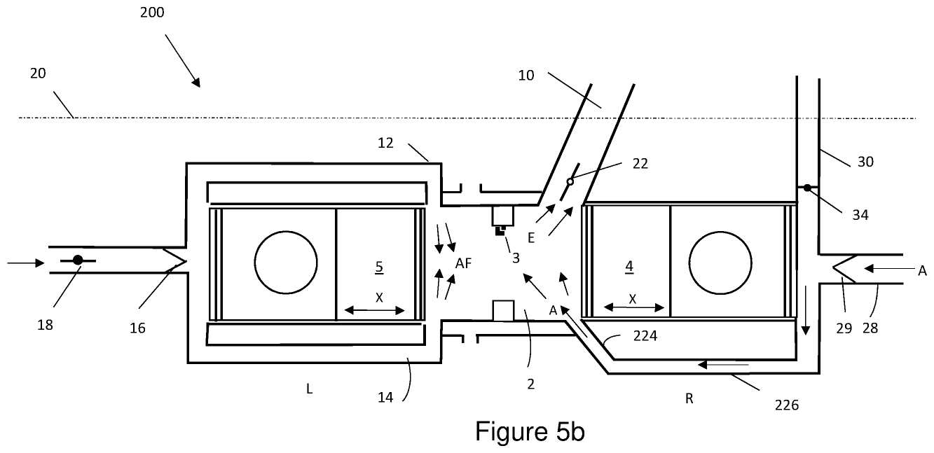

FIGS. 5a and 5b show schematic views of a third variant of the illustrated embodiment shown in FIG. 2. Many of the features of the engine of the third variant are common with the first and second variants, and so only those structural and functional features which differ are described below. Numerals of features which differ are incremented by 200 relative to FIG. 2 for clarity.

FIG. 5a shows the engine 200 operating at idle and towards the end of the power stroke. The throttle 18 is closed in order to reduce the volume of the air-fuel charge AF reaching the combustion chamber 2.

The operation of the engine 200 at idle is similar to the first variant of FIG. 3, in that the exhaust port 10 is closed by the butterfly valve 22. Exhaust gases E therefore exit the combustion chamber 2 through the secondary port operating as a secondary exhaust port 224. The transfer valve 34 is open and exhaust gas E is therefore able to escape to atmosphere. The secondary exhaust port 224 has a structure and location within the engine as described above for FIG. 2. The secondary exhaust port 224 has a smaller cross-sectional profile than the primary exhaust port 10. This maintains the trapping efficiency of the engine 200 at idle through the reduced time available to short circuit, and thus reduces harmful emissions in the exhaust gases E. The trapping efficiency is an indicator of the scavenging behaviour of an engine and is defined as the ratio of the fraction of the supplied air mass flow trapped into the cylinder to supplied air mass flow in a given period. FIG. 5b shows the engine 200 operating at power and towards the end of the power stroke. The throttle 18 is open in order to maximise the volume of the air-fuel charge AF reaching the combustion chamber 2.

The operation of the engine 200 at power is similar to the second variant of FIG. 4. The butterfly valve 22 in the exhaust port 10 is switched to open, so opening the exhaust port 10. The post combustion exhaust gases E thereby exit the combustion chamber 2 through the exhaust port 10 and vent to atmosphere above the water line 20.

The gas flow in the combustion chamber 2 is such that low pressure occurs on the power stroke. This pressure differential enables the next air-fuel charge AF to be drawn into the combustion chamber 2 when the transfer ports 12, 14 are open, and pushes exhaust gas E out through the exhaust port 10. Fresh air A is also drawn in to the combustion chamber 2 through the secondary port, now operating as a secondary transfer port 224.

The secondary transfer port 224 places fresh air A in the combustion chamber 2 adjacent the exhaust port 10. The exhaust gas charge E exits the combustion chamber 2 towards the end of the power stroke, as the transfer ports and the secondary port apertures are exposed by the reciprocating motion of the pistons. The fresh air A acts as a barrier to block the air-fuel mixture AF from reaching the exhaust port 10. This results in reduced short circuiting of the air-fuel charge AF, i.e. unburnt fuel from the air-fuel charge AF is less likely to be found in the exhaust gas E. Additionally, the location of the transfer ports 12, 14 generally on the left hand side L of the combustion chamber 2 and away from the exhaust port 10 on the right hand side of the engine 200 ensures that unburnt fuel in the exhaust gases escaping to atmosphere is minimised.

The secondary transfer port 224 may also include a control valve (not shown) operable to prevent exhaust gases entering the secondary transfer port 224 when it acts as a fresh air transfer port during operation of the engine 200 at power.

The third variant of FIGS. 5a and 5b may also include a Schnuerle porting system (not shown) as described for the first embodiment.

### Combustion Temperature Optimisation

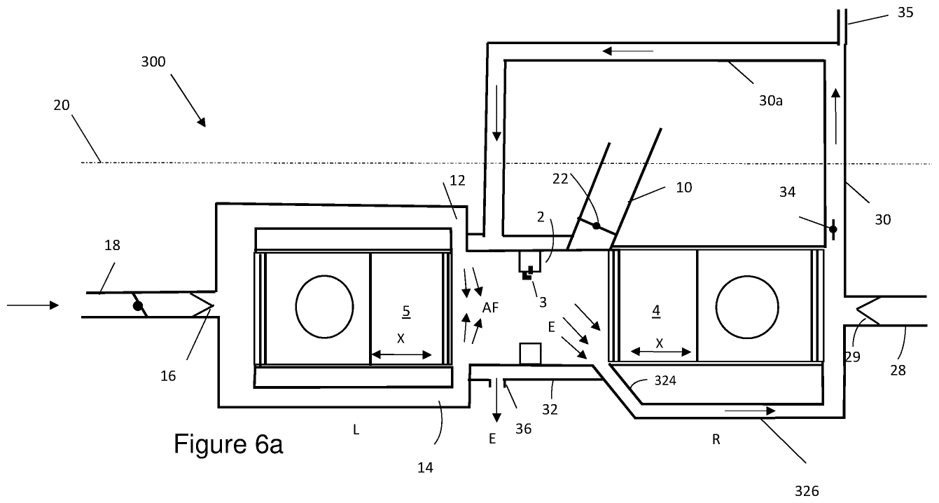

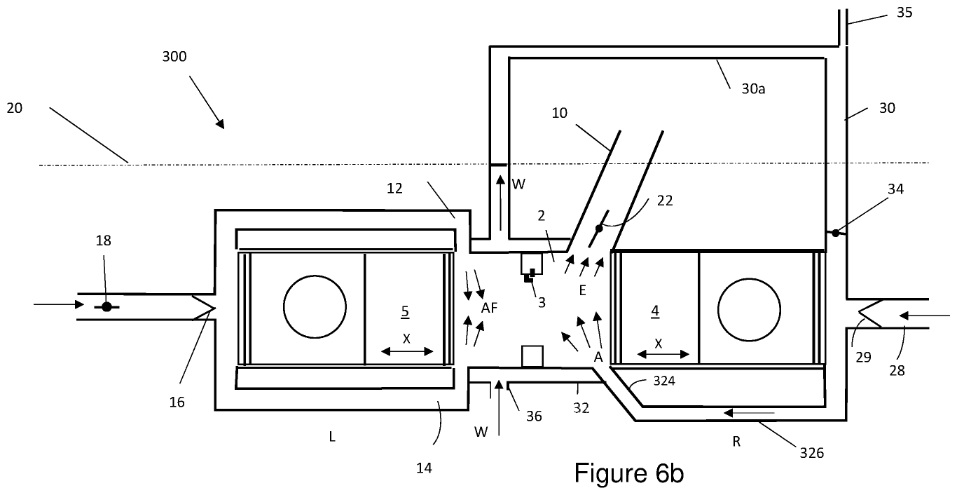

FIGS. 6a and 6b provide schematic views of operation of an engine 300 which is structurally the same as that of the engine 1 in FIG. 2. Like reference numerals denote like parts and numerals of some features which are described below are incremented by 300 relative to FIG. 2 for clarity.

Similarly to FIGS. 5a and 5b, FIGS. 6a and 6b show the secondary port operating as a two way port 324.

When the engine 300 is operating at idle (shown in FIG. 6a), the throttle 18 and the exhaust valve 22 are both closed. The secondary valve 34 is open and so on the power stroke the exhaust gases E travel through the two way port 324 operating as an exhaust port and through the transfer passage 326 to the cowling 32. The cowling 32 surrounds the volume proximate the outer wall of the combustion chamber 2. The opening 36 in the cowling 32 acts as an outlet and enables the exhaust gases E in the cowling 32 to escape into the surrounding water. This ensures that the surrounding water is continuously displaced and not able to enter the cowling 32. At idle, the engine 300 is turning over at a lower number of revolutions per minute than when at power, and the engine 300 is therefore at its coolest operational temperature. This is less than the optimum operating temperature range for efficient combustion. Directing exhaust gas E warmed by the combustion process to the cowling and so to the volume proximate the outer wall of the combustion chamber 2 serves to maintain the combustion chamber temperature, and maintain the efficiency of combustion of the engine 300. At idle the engine 300 is therefore able to run more efficiently than a conventional two stroke engine, and so regulates the emissions of unburnt hydrocarbon exhaust gases.

When the engine 300 is operating at power (shown in FIG. 6b), the throttle 18 in the intake system and the exhaust valve 22 are both open. The secondary valve 34 is closed. Air is drawn into the combustion chamber 2 through the secondary port operating as an air intake. The operation of the secondary air transfer port is as previously described.

When the engine 300 subsequently returns to idle, the throttle 18 is closed, the exhaust valve 22 is closed and the secondary or transfer valve 34 is opened. Exhaust gas E once more passes through the secondary port 324 and secondary passage 326 to the cowling 32. The exhaust gas E forces water out through the outlet 36. The exhaust gases E in the volume of the cowling 32 then serve once more to provide insulation to the combustion chamber 2 from the surrounding body of water.

If the exhaust valve 22 is opened and the secondary valve 34 is not yet fully shut, it is possible that low pressure in the combustion chamber could result in water being ingested into the engine 1 through the cowling 32. To prevent this, the pressure bleed 35 equalizes the pressure between the cowling and the engine. When the engine 1 is at idle, exhaust gases are directed to the cowling through the exhaust outlet and the further transfer port 30a and the dimensions of the pressure bleed 35 are such that exhaust gas E primarily does not pass through the pressure bleed 35. The pressure bleed 35 is therefore insensitive to the exhaust gas flow present when the engine is at idle or low load, and so maintains the ability of the exhaust gases E to displace the cooling water in the cowling 32. It is possible that a small volume of exhaust gas E could escape or bleed through the pressure bleed 35, however the exhaust gases E primarily exit the cowling 32.

The cowling 32 thereby contains a volume of either insulating exhaust gas with the engine 300 operating at idle, or cooling water with the engine 300 operating at power. By selectively directing either insulating exhaust gases E or cooling water W to the volume proximate the outer wall of the chamber, the engine 300 can be maintained within (or at least closer to) its optimal operating temperature range. This controls the efficiency of the combustion process and hence regulates unburnt hydrocarbon emissions from the engine 300. The volume of exhaust gas to the cowling 32 may alternatively be actively controlled so that the cowling is partially filled with cooling water and exhaust gases, and/or a continuous gas flow is passed through the cowling 32 containing a volume of water.

In an alternative variant, the secondary port may connect into a transfer passage which either directly connects to the cowling 32, or selectively may be connected to either the cowling 32 or to the secondary chamber on the right hand R of the engine 300.

Where, in alternative variants of internal combustion engine, a secondary port is not included, exhaust gas from the exhaust port is instead directed to the cowling when the engine is at idle. When the engine is at power, the exhaust gas supply to the cowling is switched off and water is then able to enter the cowling to cool the engine, as described above.

The secondary transfer port 324 may also include a control valve (not shown) as described for previous embodiments. The scavenging efficiency of the embodiment may also be improved by the use of a Schnuerle porting system (not shown) as described for the first embodiment.

### Porting and Cowling Arrangements in Single Ended Piston Engines

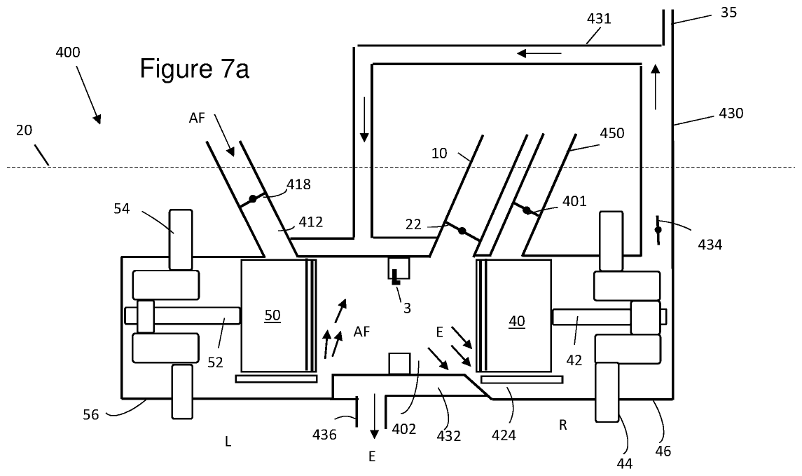

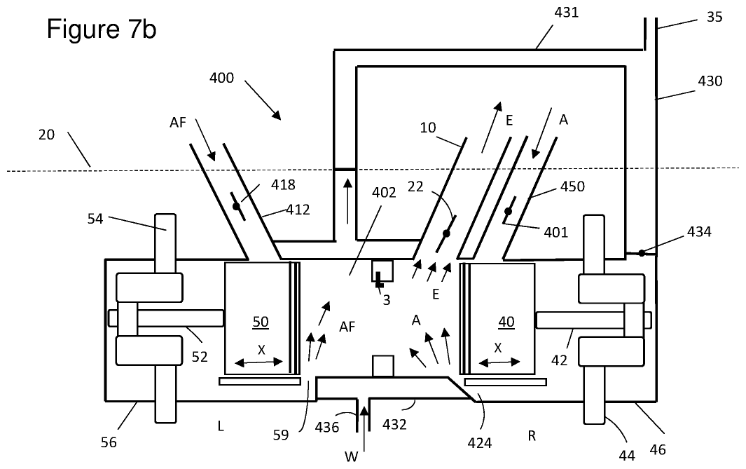

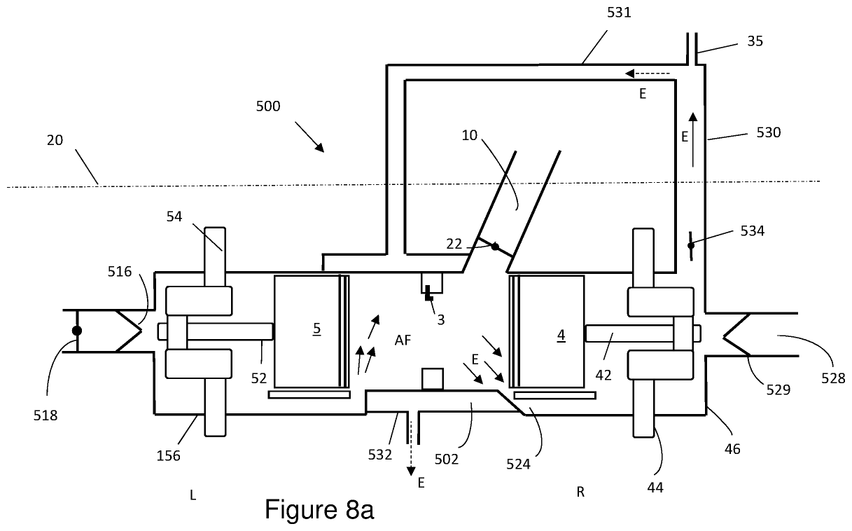

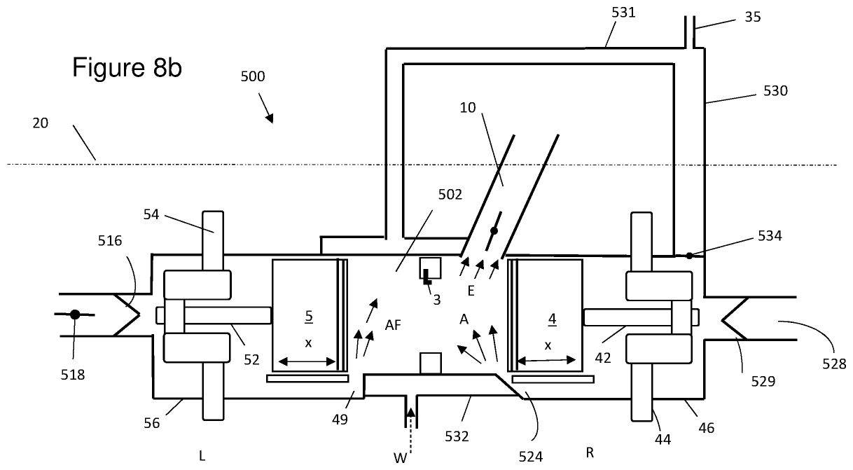

FIGS. 7a, 7b and 8a, 8b show embodiments of the invention wherein instead of double-headed pistons each with a sealed power transfer mechanism (as in FIGS. 1-6), more conventional, single-ended pistons each with a crank and con-rod power transfer arrangement and piston porting are used. Again the engine shown is intended to work on a two-stroke cycle, but variants operating a four-stroke cycle are also envisaged as will be apparent to those skilled in the art.

FIGS. 7a, 7b and 8a, 8b are schematic views of an opposed piston engine having two pistons arranged to reciprocate in a combustion chamber 402 similarly to the previous embodiments. The opposing pistons 40, 50 are shown in a position corresponding to approximately the end of the power stroke, i.e. generally around bottom dead centre. Each piston 40, 50 is a single ended piston connected via a connecting rod 42, 52 to a crankshaft 44, 54. Each crankshaft 44, 54 is housed within a crankcase 46, 56. The porting arrangements in FIGS. 7a and 7b differ from those in FIGS. 8a and 8b, as will be described below.

Many of the features of the engine of the illustrated embodiments of FIGS. 7a and 7b and FIGS. 8a and 8b are common with the previous embodiments, and so only those structural and functional features which differ are described below.

FIGS. 7a and 7b provide a further illustrated embodiment of a piston ported two stroke engine, each single ended piston having a crank and connecting rod arrangement. FIGS. 8a and 8b provide a variant of the illustrated embodiment of FIGS. 7a and 7b, with a two stroke engine having a reed valve intake arrangement.

In FIGS. 7a, 7b and 8a, 8b, a main transfer port 412 is operated by the reciprocating action of the piston 50 moving in a generally horizontal direction X within the cylinder. A throttle 418 is located in the main transfer port 412, similarly to the previous embodiment.

The main transfer port 412 draws air from the atmosphere into the crankcase 56 when the piston 50 on the left hand side L of the engine 400 exposes the opening of the main transfer port 412 towards the end of the compression stroke. Air is drawn in by the vacuum created during the compression stroke of the piston. Fuel F is added to the air during part of the induction process. During the power stroke, the air-fuel mixture is compressed, until towards the end of the power stroke the piston 50 exposes an intake opening 59 into the combustion chamber 402. The air-fuel charge AF is drawn into the combustion chamber 402 due to the pressure differential between the crankcase 56 and the combustion chamber 402, and this forces the exhaust gas E from the combustion chamber 402 through an exhaust port 10.

The exhaust port 10 has an aperture into the combustion chamber 402 located similarly to previous embodiments in an upper region of the combustion chamber 402 and operates as for previous embodiments. The exhaust port has an exhaust valve 22 operable between an open and a closed position.

The illustrated embodiment of FIGS. 7a and 7b has a secondary air transfer port 450 located on the right hand side R of the engine 400. The secondary air transfer port 450 has an aperture into the crankcase 46. The secondary air transfer aperture is opened by the action of the right hand piston 40 reciprocating in a generally horizontal direction X. As for previous embodiments, the engine may be operated generally in any orientation. The secondary air transfer port 450 is open when the piston is towards the end of the compression stroke. The secondary air transfer port has a secondary air intake valve 401 operable between an open and a closed position.

A secondary port 424 opens into the combustion chamber 402. The opening of the secondary port 424 into the combustion chamber 402 is also located generally on the right hand side of the engine 400. The opening of the secondary port 424 is located generally opposite the opening of the exhaust port 10 within the combustion chamber 402. The exhaust port 10 aperture into the combustion chamber 402 is located generally in the upper region of the combustion chamber, nearest to the waterline 20, whilst the secondary port 424 opening is opposite the exhaust port and generally in the lower region of the combustion chamber 402. The secondary port 424 is opened and closed by the action of the right hand piston 40, similarly to the exhaust port 10. The secondary port 424 extends into the crankcase 46.

An exhaust gas outlet 430 extends from the crankcase 46 and exits to atmosphere above the waterline 20. A transfer valve 434 is located in the exhaust gas outlet 430. The transfer valve 434 is selectively movable between a closed position in which the exhaust gas outlet 430 is closed, and an open position in which the exhaust gas outlet 430 is open. In the illustrated embodiment of FIGS. 7a, 7b and 8a, 8b the transfer valve 434 is shown as a butterfly valve. In alternative embodiments, various known valve designs could be used.

In order to provide selective insulation and cooling of the volume proximate the outer wall of the combustion chamber 402, a cowling 432 is fitted to the engine 400. The cowling 432 contains a volume surrounding the outer wall of the combustion chamber 2. The cowling 432 provides a jacketed area surrounding the outer wall of the combustion chamber 402. A transfer conduit 431 connects the cowling 432 to the exhaust outlet 430 to enable warm exhaust gases E to transfer to the cowling 432 when the engine is operating at idle. The exhaust outlet 430 does not operate as an exhaust outlet and is closed to the atmosphere except for a pressure bleed 35. The cowling 432 also has an opening 436 fluidically connecting the volume to the surrounding body of water.

The pressure bleed 35 is connected to the transfer conduit 431 and operates as for the previous embodiment.

As for the previous embodiments described above, the secondary port can be operated as a secondary exhaust port; a secondary air transfer port; or as a two way port so that at idle the secondary port operates as a secondary exhaust port and at power the secondary port operates as a secondary air transfer port. The porting arrangements also serve to provide selective insulation or cooling to a volume surrounding the outer wall of the combustion chamber.

### Secondary Exhaust Port

FIG. 7a shows the engine 400 operating at idle. When the engine 400 is at idle, the throttle 418 in the air transfer port 412 is closed. Towards the end of the power stroke the piston 40 exposes the apertures of the exhaust port 10 and the secondary port 424. The exhaust valve 22 is closed and exhaust gases are therefore unable to exit the combustion chamber 402 through the exhaust port 10. The secondary air intake valve 401 in the secondary air transfer port 450 is also closed and the secondary transfer port is therefore not in use. Exhaust gases E exit the combustion chamber 402 through the secondary port 424. The secondary port 424 operates as a secondary exhaust port. The transfer valve 434 in the exhaust gas outlet 430 is open and enables the exhaust gases E to escape to atmosphere from the crankcase 46.

Since the secondary port 424 has a smaller cross-section than the exhaust port 10, the pressure in the combustion chamber 402 is maintained and the efficiency of combustion is improved, as described for the first embodiment above.

When the engine 400 operates at power (not shown), the throttle 418 in the main transfer port 412 is open, the exhaust valve 22 in the exhaust port 10 is open, the secondary air intake valve 401 in the secondary air transfer port 450 is shut and the transfer valve 434 in the exhaust gas outlet 430 is shut. The secondary port 424 is not in use and exhaust gas E exits the combustion chamber 402 through the main exhaust port 10.

### Secondary Transfer Port

In the illustrated embodiment of FIG. 7b, the secondary port 424 operates as a secondary fresh air transfer. FIG. 7b shows the engine 400 operating at power. The throttle 418 located in the main transfer port 412 is therefore open. The exhaust port 10 and the exhaust valve 22 are open, and exhaust gases E escape to atmosphere directly through the exhaust port 10. The secondary air intake valve 401 in the secondary air transfer port 450 is also open, in order to provide a supply of fresh air A to the crankcase 46 when opened by the piston 40 towards the end of the compression stroke. As described for the second embodiment above, towards the end of the power stroke, the reciprocating motion of the piston 40 exposes the exhaust port 10 and the secondary port 424. The reciprocating motion of the left hand piston 50 exposes the transfer aperture 59. A new air-fuel charge AF is inducted into the combustion chamber 402 and exhaust gases E exit the combustion chamber 402 through the exhaust port 10. Fresh air from atmosphere is drawn into the combustion chamber 402 from the crankcase 46 through the secondary port 424, and acts as a barrier between the new air-fuel charge AF and the exhaust port 10. Any excess gas drawn through the combustion chamber 402 once the exhaust gases E are removed is fresh air A from the secondary port 424. Similarly to embodiment 2 above, the risk of unburnt fuel passing through the combustion chamber 402 and out to atmosphere is reduced.

### Two-Way Secondary Port

The engine 400 of FIGS. 7a and 7b may be combined as described for the first embodiment in FIGS. 5a and 5b, so that the secondary port 424 operates as a two way port. When the engine 400 operates at idle the secondary port 424 operates as a secondary exhaust port as previously described. When the engine 400 is at power, the secondary port 424 operates as a secondary air transfer port to supply fresh air to the combustion chamber 402 and provide a barrier to the air-fuel mixture AF leaving the combustion chamber 402. The operation of the secondary port 424 is therefore as described in detail above. The engine 400 of FIGS. 7a and 7b may also include a Schnuerle porting system (not shown) as described for the first embodiment.

### Combustion Temperature Optimisation

The cowling 432 provides selective insulation and cooling of the combustion chamber 402. This maintains the combustion process as close as possible to an optimum temperature range, and hence reduces inefficient or incomplete combustion and thereby unburnt hydrocarbon exhaust emissions. The structure and operation of the cowling 432 is as described above for the fourth variant of the first embodiment in FIGS. 6a and 6b. FIG. 8a shows the engine operating at idle. FIG. 8b shows the engine operating at power. The secondary port in the second embodiment operates as a two way port, as described above.

When the engine 400 is operating at idle (shown in FIG. 7a), the throttle 418 and the exhaust valve 22 are both closed. The transfer valve 434 is open and so on the power stroke the exhaust gases E exit the combustion chamber 402 through the two way port 424 operating as an exhaust port. Exhaust gases E pass through the crankcase 46, through the exhaust outlet 430 and the transfer conduit 431, to the cowling 432. The opening 436 in the cowling 432 acts as an outlet and enables the exhaust gases E in the cowling 432 to escape into the surrounding water. This ensures that the surrounding water is continuously displaced and not able to enter the cowling 432.

At idle, the engine 400 is turning over at a lower number of revolutions per minute than when at power, and the engine 400 is therefore at its coolest operational temperature. This is less than the optimum operating temperature range for efficient combustion. Directing exhaust gas E warmed by the combustion process to the cowling 432 and so to the volume proximate the outer wall of the combustion chamber 2 serves to maintain the combustion chamber temperature, and maintain the efficiency of combustion of the engine 300. At idle, the engine 400 is therefore able to run more efficiently than a conventional two stroke engine, and so regulates the emissions of unburnt hydrocarbon exhaust gases.

When the engine 400 is operating at power (shown in FIG. 7b), the transfer valve 434 closes the exhaust outlet 430. With the exhaust outlet 430 shut, any gas flow to the cowling 432 is prevented. Water W from the surrounding body of water is then able to ingress into the cowling 432 through opening 436. Water enters the cowling 432 thus surrounding the outer wall of the combustion chamber 2 and providing cooling of the combustion chamber 402.

Water W in the body of water surrounding the engine 400 can therefore enter the cowling 432 via the opening 436 in the cowling 432. Water W fills the cowling until it reaches the level 20 of the surrounding body of water. Since the engine 400 at power operates at a higher temperature than when at idle, and potentially at a higher than optimal temperature range, water in the cowling 432 advantageously provides a source of cooling for the combustion chamber 402. The temperature of the combustion chamber is thereby maintained at or closer to an optimum temperature range, and so assists in maintaining unburnt hydrocarbon emissions at as low a level as possible.

When/if the engine 400 subsequently returns to idle, the throttle 418 is closed, the exhaust valve 22 is closed and the secondary or transfer valve 434 is opened. Exhaust gas E once more passes through the secondary port 424, exhaust outlet 430 and transfer conduit 431 to the cowling 432. The exhaust gas E forces water out through the outlet 436. The exhaust gases E in the volume of the cowling 432 then serves once more to provide insulation to the combustion chamber 2 from the surrounding body of water.

The cowling 432 thereby contains a volume of either insulating exhaust gas with the engine 400 operating at idle, or cooling water with the engine 400 operating at power. By selectively directing either insulating exhaust gases E or cooling water W to the volume proximate the outer wall of the chamber, the engine 400 can be maintained within (or at least closer to) its optimal operating temperature range. This controls the efficiency of the combustion process and hence regulates unburnt hydrocarbon emissions from the engine 400.

Where, in alternative embodiments of internal combustion engine, a secondary port is not included, exhaust gas from the exhaust port is instead directed to the cowling when the engine is at idle. When the engine is at power, the exhaust gas supply to the cowling is switched off and water is then able to enter the cowling to cool the engine, as described above.

FIGS. 8a and 8b provide a schematic view through a two stroke engine having an opposed piston arrangement with a single sided piston and a power transfer mechanism similar to the embodiments shown in FIGS. 7a and 7b. The embodiments of FIGS. 8a and 8b differ in the arrangement of the ports. The engine 500 operates in a similar manner to the engine of FIGS. 7a and 7b, except that the intake system is located at an end of the crankcase 156 opposing the piston 50. A throttle 518 and a one way valve 516 are located in the intake system similarly to the first and second embodiments.

Many of the features of the engine of the illustrated embodiments of FIGS. 8a and 8b are common with the previous embodiments, and so only those structural and functional features which differ are described here.

On the right hand side R of the engine, a secondary port 524 extends into the crankcase 46. A transfer conduit 530 extends from the crankcase 46 to atmosphere or is connected to a further transfer conduit 531. The further transfer conduit 531 connects the transfer conduit 530 and crankcase 46 with a cowling 532 defining a volume proximate the outer wall of the combustion chamber 2. An air inlet 528 extends from the crankcase 46 and exits to atmosphere. A one way valve 529 allows gas flow into the engine 500 only, in a direction towards the combustion chamber 2.

All other details remain as for previous embodiments, and the operation of the engine 500 is such that the operation of the secondary port 524 as either an exhaust port or as a transfer port or as a two-way port remains as for previous embodiments. An additional secondary port provides for a secondary exhaust port and a secondary transfer port arrangement to be combined. Exhaust gas passing through the secondary port may exit to atmosphere or may be directed to the cowling 532 to provide insulation of the combustion chamber 502 at idle. The volume in the cowling 532 may selectively be connected to the exhaust gas when the engine operates at idle or water may be allowed to ingress to cool the engine when operating at power. The engine 500 of FIGS. 8a and 8b may also include a Schnuerle porting system (not shown) as described for the first embodiment.

In FIG. 9 a variant is shown of the embodiment in FIGS. 8a and 8b in which the engine 600 has transfer ports 12, 14 both exposed to the combustion chamber when the single-headed piston is approximately at the end of the power stroke, i.e. generally around bottom dead centre. A fuel injector 650 is shown attached to transfer port 12, although it could be located on the transfer port 14 or a similar location between the combustion chamber and intake air. The secondary port 624 is operable as either an exhaust port or a transfer port as in the previous embodiment of FIGS. 8a and 8b, and is connected to the transfer conduit 630, although the figure is simplified and doesn't show the connection. The transfer conduit 630 connects to the cowling 632 to selectively control the temperature of the engine by conveying cooling water and/or cooling water to the cowling 632.

The embodiment also includes Schnuerle ports 640 located on the right side of the engine adjacent to the exhaust port 10 and secondary port 624. The Schnuerle ports are angled within the cylinder to direct the flow path of the exhaust gas towards the exhaust port 10 or the secondary exhaust port 24.

It will be clear to the skilled person that variations to the design and location of the Schnuerle porting arrangement are available. For example, in an alternative embodiment the secondary port may be positioned so that only be a single Schnuerle port is used, or the Schnuerle ports may be located differently within the combustion chamber, for example, adjacent the left hand piston 5.

A single piston variant with a secondary port operating as a dedicated secondary exhaust port is shown in FIGS. 10a and 10b. The submerged internal combustion engine has a piston 4 configured to reciprocate in a combustion chamber 2. A power transfer mechanism comprises a connecting rod 42 coupling the piston 4 to a crankshaft 44 similar to that of the embodiments of FIGS. 7 and 8. The crankshaft 44 is housed within a crankcase 46. Alternatively a power transfer mechanism similar to that of the embodiments of FIGS. 1 to 6 may be used.

A one way valve 16 located in the air intake system ensures that the air-fuel charge only travels towards the combustion chamber 2. The volume of air-fuel charge reaching the combustion chamber 2 is controlled by a throttle 18 located in the air intake system. The one way valve 16 and the throttle are as described previously. The intake system is fluidly coupled to an air transfer port 740, e.g. a Schnuerle port or any other known porting arrangement.

The combustion chamber has a primary exhaust port 10 with an exhaust valve 22, and a secondary exhaust port 724. The combustion chamber 2 has a source of ignition, such as a spark plug 3, located within the combustion chamber 2.

When the engine 100 is operating at idle, as in FIG. 10a, the throttle 18 is closed. This reduces the volume of the air-fuel mixture flowing into the combustion chamber 2 to a minimum, and controls the air-fuel charge received by the combustion chamber 2 for each revolution of the engine 100.

The exhaust valve 22 is also shut when the engine 100 is at idle in order to close off the exhaust port 10 leading from the combustion chamber 2. Post combustion exhaust gases E instead exit the combustion chamber 2 during the power stroke via the secondary port 724 operating as a secondary exhaust port 724. The secondary exhaust port 724 has a cross-sectional profile that is smaller than the cross-sectional profile of the primary exhaust port 10 to optimise the scavenging efficiency at idle, as in previous embodiments.

FIG. 10b shows the engine 100 at power. At power the throttle 18 is open, the primary exhaust valve is open and exhaust gases E exit the combustion chamber through the primary exhaust port 10. The secondary exhaust port 724 may be selectively opened to provide an auxiliary exhaust port during power.

The secondary exhaust port 724 may connect directly to atmosphere or may convey exhaust gases towards a cowling (not shown) to control the temperature of the engine, as in previous embodiments.

The selective insulation or cooling of the combustion chamber, by controlling the volume of cooling water or exhaust gas conveyed to the cowling, is suitable to any internal combustion engine submerged in a body of water. Examples of internal combustion engines may include, for example, two-stroke engines, four-stroke engines and Wankel engines.

This is demonstrated in FIGS. 11a and 11b which show a simplified view of an internal combustion engine 800 partially submerged in a body of water up to a waterline 20. The engine 800 includes an air intake 17 that controls the volume of the air-fuel mixture AF flowing into the combustion chamber (not shown). A primary exhaust port 10 allows post combustion exhaust gases to leave the combustion chamber and exit to atmosphere. The volume of exhaust gases that escape to atmosphere is controlled by an exhaust valve 22. In this example the secondary transfer port 824 acts as a secondary exhaust port 824 that opens to the primary exhaust port 10 between the exhaust valve and the combustion chamber, although it will be clear that the secondary exhaust port 824 may also connect directly to the combustion chamber as in previous embodiments.

When the engine 800 is operating at idle (shown in FIG. 11a), the exhaust valve 22 is closed so that on the power stroke the exhaust gases E exit the combustion chamber through the secondary exhaust port 824. Exhaust gases E pass through the transfer passage 826 and the transfer conduit 830, to the cowling 832. The openings 836 in the cowling 832 act as outlets and enable the exhaust gases E in the cowling 832 to escape into the surrounding water. This ensures that the surrounding water is continuously displaced and not able to enter the cowling 832.

Directing exhaust gas E warmed by the combustion process to the cowling 832 and maintains the efficiency of combustion of the engine 300 during idle and so regulates the emissions of unburnt hydrocarbon exhaust gases.

When the engine 800 is operating at power (shown in FIG. 11b) the exhaust valve 22 is opened and exhaust gases primarily exit through the primary exhaust port 10. A transfer valve (not shown) may operate to close the secondary exhaust port 824. With the secondary exhaust port 824 shut, any gas flow to the cowling 832 is prevented. Water W from the surrounding body of water is then able to ingress into the cowling 832 through openings 836. Water enters the cowling 832 thus surrounding the outer wall of the combustion chamber and providing cooling of the combustion chamber. This process can be regulated to optimise the temperature of the combustion chamber to reduce inefficient or incomplete combustion, and thereby unburnt hydrocarbon exhaust emissions, by controlling the volume of exhaust gas that enters the cowling 832.

When the engine 800 subsequently returns to idle, the exhaust valve 22 is closed and the primary exhaust port does not allow exhaust gases to escape directly to atmosphere. Instead exhaust gases convey through the secondary exhaust port 824 to the cowling.

Although the invention has been described above with reference to one or more preferred embodiments, it will be appreciated that various changes or modifications may be made without departing from the scope of the invention as defined in the appended claims.

1-52. (canceled)

53. An internal combustion engine comprising:
a pair of pistons in an opposed piston arrangement and a combustion chamber shared by the pair of opposed pistons, the pistons are configured to reciprocate within the combustion chamber,
wherein the combustion chamber has a two-way port configured to selectively convey exhaust gas away from the combustion chamber, or to convey intake air into the combustion chamber.

54. An internal combustion engine according to claim 53, wherein the two-way port is configured selectively to either i) convey exhaust gas away from the combustion chamber and not to simultaneously convey intake air into the combustion chamber, or ii) convey intake air into the combustion chamber and not to simultaneously convey exhaust gas away from the combustion chamber, according to an engine setting.

55. An internal combustion engine according to claim 53, wherein the engine further comprises an exhaust port configured to be selectively opened and closed such that when the exhaust port is closed the two-way port is configured to convey exhaust gas away from the combustion chamber, and when the exhaust port is open the exhaust port is configured to convey exhaust gas away from the combustion chamber and the two-way port is configured to convey intake air into the combustion chamber.

56. An internal combustion engine according to claim 55, wherein the two-way port has a smaller cross-sectional profile than a cross-sectional profile of the exhaust port.

57. An internal combustion engine according to claim 53, wherein during an engine cycle the two-way port has a shorter open duration than the open duration of the exhaust port.

58. An internal combustion engine according to claim 53, wherein during an engine cycle the exhaust port opens prior to the two-way port.

59. An internal combustion engine according to claim 53, wherein the two-way port and the exhaust port open into the combustion chamber generally at a first end of the combustion chamber.

60. An internal combustion engine according to claim 53, further comprising a transfer port configured to convey an air-fuel mixture to the combustion chamber.

61. An internal combustion engine according to claim 60, wherein the two-way port and the exhaust port open into the combustion chamber generally at a first end of the combustion chamber, and wherein the transfer port opens into the combustion chamber generally at a second end of the combustion chamber opposite the first end.

62. An internal combustion engine according to claim 53, wherein the two-way port is selectively fluidly connected to an exhaust gas outlet or to an air inlet, and wherein a transfer valve is located in a transfer conduit between the air inlet and the exhaust gas outlet, the transfer valve selectively movable between a closed position in which the two-way port is fluidly connected to the air inlet, and an open position in which the two-way port is fluidly connected to the exhaust gas outlet.

63. An internal combustion engine according to claim 62, wherein the engine further comprises an exhaust port configured to be selectively opened and closed such that when the exhaust port is closed the two-way port is configured to convey exhaust gas away from the combustion chamber, and when the exhaust port is open the exhaust port is configured to convey exhaust gas away from the combustion chamber and the two-way port is configured to convey intake air into the combustion chamber, and wherein the exhaust port has an exhaust valve selectively movable between a closed position in which the exhaust port is closed and an open position in which the exhaust port is open, and the exhaust valve and the transfer valve are configured such that when the exhaust valve is open the transfer valve is closed, and vice versa.

64. An internal combustion engine according to claim 63, wherein the air inlet has a one-way valve to permit air to flow from the air inlet to the two-way port.

65. An internal combustion engine according to claim 60, wherein the transfer port is fluidly connected to an intake for admitting an air-fuel mixture, and further comprising a throttle valve between the intake and the transfer port, the throttle valve movable between a closed position and an open position.

66. An internal combustion engine according to claim 63, further comprising a transfer port configured to convey an air-fuel mixture to the combustion chamber, wherein the transfer port is fluidly connected to an intake for admitting an air-fuel mixture, and further comprising a throttle valve between the intake and the transfer port, the throttle valve movable between a closed position and an open position, wherein the throttle valve and the exhaust valve are configured such that when the throttle valve is open the exhaust valve is open, and vice versa.

67. An internal combustion engine according to claim 65, further comprising a one-way valve between the throttle valve and the transfer port to permit the air-fuel mixture to flow from the intake to the transfer port.

68. An internal combustion engine according to claim 53, wherein a respective intake is associated with each of the pair of pistons, one intake is adapted to convey an air-fuel mixture to the combustion chamber, and the other intake is adapted to convey air to the combustion chamber, each intake having a throttle valve.

69. An internal combustion engine according to 68, wherein the throttle valves are configured to open and close simultaneously.

70. An internal combustion engine comprising:
at least one piston configured to reciprocate within a combustion chamber, wherein the combustion chamber has:
a primary exhaust port having a substantially open configuration for carrying exhaust gas away from the chamber and a substantially closed configuration wherein exhaust gas substantially cannot pass through the primary exhaust port;
and a secondary exhaust port configured to convey exhaust gas away from the combustion chamber when the primary exhaust port is substantially closed.

71. An internal combustion engine according to claim 70, wherein the secondary exhaust port has a smaller cross-sectional profile than a cross-sectional profile of the primary exhaust port.

72. An internal combustion engine according to claim 70, wherein during an engine cycle the secondary exhaust port has a shorter open duration than the open duration of the primary exhaust port.

73. An internal combustion engine according to claim 70, wherein during an engine cycle the exhaust port opens prior to the secondary exhaust port.

74. An internal combustion engine according to claim 70, wherein the primary and secondary exhaust ports open into the combustion chamber generally at a first end of the combustion chamber.

75. An internal combustion engine according to claim 74, further comprising a transfer port configured to convey an air-fuel mixture to the combustion chamber, and wherein the transfer port opens into the combustion chamber generally at a second end of the combustion chamber opposite the first end.

76. An internal combustion engine according to claim 70, wherein the primary exhaust port has an primary exhaust valve selectively movable between a closed position in which the primary exhaust port is closed and an open position in which the primary exhaust port is open, and the secondary exhaust port has a secondary exhaust valve selectively movable between a closed position in which the secondary exhaust port is closed and an open position in which the secondary exhaust port is open, the primary exhaust valve and the secondary exhaust valve are configured such that when the primary exhaust valve is open the secondary exhaust valve is closed and vice versa.

77. An internal combustion engine according to claim 75, wherein the transfer port is fluidly connected to an intake for admitting an air-fuel mixture, and further comprising a throttle valve between the intake and the transfer port, the throttle valve movable between a closed position and an open position.

78. An internal combustion engine according to claim 70, wherein the at least one piston includes a pair of pistons in an opposed piston arrangement and the combustion chamber is shared by the pair of opposed pistons.

79. An internal combustion engine according to claim 78, wherein a respective intake is associated with each of the pair of pistons, one intake is adapted to convey an air-fuel mixture to the combustion chamber, and the other intake is adapted to convey air to the combustion chamber, each intake having a throttle valve.

80. An internal combustion engine according to claim 70, wherein the secondary exhaust port is a two-way port configured to selectively convey exhaust gas away from the combustion chamber, or to convey intake air into the combustion chamber.

81. An internal combustion engine comprising:
at least two pistons configured in an opposed piston arrangement to reciprocate within a common combustion chamber,
a transfer port generally adjacent a first end of the combustion chamber and configured to provide an air and fuel mixture to the chamber,
an exhaust port generally adjacent a second end of the combustion chamber generally opposite the first end and configured to convey exhaust gas away from the chamber,
and a secondary transfer port located generally adjacent the second end of the combustion chamber and generally opposing the exhaust port,
wherein the secondary transfer port is configured to induct air into the combustion chamber.

82. An internal combustion engine according to claim 81, wherein the secondary transfer port has a smaller cross-sectional profile than the cross-sectional profile of the exhaust port.

83. An internal combustion engine according to claim 81, wherein the secondary transfer port is configured to induct air into the combustion chamber as the exhaust port conveys exhaust gas away from the chamber.

84. An internal combustion engine according to claim 81, wherein the secondary transfer port is selectively fluidly connected to an air inlet having a one-way valve to permit air to flow from the air inlet to the secondary transfer port.

85. An internal combustion engine according to claim 81, wherein during an engine cycle the secondary transfer port has a shorter open duration than the open duration of the exhaust port.

86. An internal combustion engine according to claim 81, wherein during an engine cycle the exhaust port opens prior to the secondary transfer port.

87. An internal combustion engine according to claim 81, wherein the secondary transfer port is a two-way port configured to selectively convey exhaust gas away from the combustion chamber, or to convey intake air into the combustion chamber.

88. An internal combustion engine according to claim 81, wherein the exhaust port is a primary exhaust port, and further comprising a secondary exhaust port, the primary exhaust port having a substantially open configuration for carrying exhaust gas away from the chamber and a substantially closed configuration wherein exhaust gas substantially cannot pass through the primary exhaust port, and the secondary exhaust port is configured to convey exhaust gas away from the combustion chamber when the primary exhaust port is substantially closed.
